(19) United States
(12) Patent Application Publication
(10) Pub. No.: US 2002/0060263 A1
(43) Pub. Date: May 23, 2002

(54) Coil winding apparatus to fabricate coil-wound article for electric motor, generator and alternator

(75) Inventors: Sang S. Nam, Kyungbuk (KR); Hyo S. Hyun, Kyungbuk (KR); Yang T. Lim, Seoul (KR)

Correspondence Address: JOHN K. PARK, PARK & SUTTON LLP, SUITE 1110, 3255 WILSHIRE BLVD., LOS ANGELES, CA, 90010, US

(73) Assignee: YANG TAEK LIM

(21) Appl. No.: 09/992,273

(22) Filed: Nov. 14, 2001

(30) Foreign Application Priority Data
Nov. 21, 2000 (KR) 20-2000-0032507

(51) Int. Cl. H02K 15/085

(52) U.S. Cl. 242/432; 29/596

(57) ABSTRACT

A coil winding apparatus to fabricate a coil-wound article comprises a mandrel having an outer periphery, first and second side ends through which is axially formed an orifice to define an inner periphery. Slots are radially formed along each side section of the outer periphery to allow communication between the inner and outer peripheries. Grooves are circularly formed to intersect the slots. Upright portions of the hooks are radially aligned with the slots to enable their reciprocal movements through the slots. Retainer members sustain the hooks by the holes. Elastic rings are worn in and along the grooves to elastically maintain each upright portion of the corresponding hooks below the outer periphery of the mandrel. Adjusters are detachably inserted through the orifice to allow the upright portions to remain above the outer periphery of the mandrel.

### CLAIMING FOREIGN PRIORITY

The applicant claims and requests a foreign priority, through the Paris Convention for the Protection of Industry Property, based on a utility model application filed in the Republic of Korea (South Korea) with the filing date of Nov. 21, 2000, with the utility model application number 20-2000-0032507, by the applicant. (See the attached declaration)

### BACKGROUND OF THE INVENTION

The present invention relates to an apparatus for winding coils thereon. More specifically, this invention relates to an improved coil winding apparatus for electric motors, generators and alternators to substantially simplify coil winding mechanism while expediting coil windings.

As is conventionally known, a brushless motor adopting alternating current (AC) and direct current (DC) has an outer stator surrounding an inner rotor in which the rotor is provided to rotate within the stator.

In most electric motors, the stator includes a number of regularly spaced radially oriented teeth along its inner periphery, which define a corresponding number of slots. The teeth and slots extend along the entire axial length of the stator. Through various techniques which are well known to those skilled in the field, electrical windings are positioned in the slots between the teeth from one end of the stator to another, and around the teeth at the opposite ends of the stator. In this manner, the electrical windings are precisely oriented with respect to the rotor so that AC or switched DC voltage applied to the windings will induce a magnetic field which has a known, predetermined orientation. The electro-magnetic field is designed to react with permanent magnets or inductive windings on the rotor to turn the rotor in a desired direction.

It can be difficult and time consuming to install the electrical windings into a slotted stator, and a fair amount of complicated machinery has been developed over the years to do this. In addition to the manufacturing difficulties presented by the slotted stator configuration, the presence of the teeth which define the slots creates magnetic discontinuities, which can affect the efficiency of the motor. In addition, the presence of the teeth limits the number of windings which can be positioned in the critical area of the stator adjacent to the rotor. This also adversely affects the efficiency of the motor. If the entire area on the stator which is adjacent to the rotor could be filled with conductors, motor efficiency would increase, and losses due to factors such as hysteresis would be lessened.

U.S. Pat. No. 5,197,180 discloses a device to improve a motor efficiency by securing effective conductors that a motor requires, by filling the entire area of the stator with coils to thereby decrease losses caused by hysterisis.

However, the cited coil winding device may incur defectives in the course of coil winding and forming the two-layered flat web, and disadvantageously requires precision devices to prevent incurrence of the defectives. That is, when flattening the coil wound formation to form the flat web, the coils may lose an even alignment thereof and be tangled, resulting in critical effect on the motor performance. Further, in the course of rolling the flat web to form the circular shape there is additionally required an extra device and process for adjusting radial measurements of the circular shape to a target size in accordance to a motor, thereby increasing production cost while damaging production efficiency.

### SUMMARY OF THE INVENTION

The invention is contrived to overcome the conventional disadvantages. Therefore, it is an object of the present invention to provide a coil winding apparatus for realizing a coil-wound article in a cylindrical formation which is applicable to a stator without deformation of the coil-wound article. Another object is to provide a coil winding apparatus for implementing a high efficiency motor while substantially decreasing production costs and defective rates.

To achieve the above-described objects, a coil winding apparatus to fabricate a coil-wound article for an electric motor, an electric generator, or an electric alternator, according to the present invention, comprises a mandrel having an outer periphery, first and second side ends. Through the first and second side ends of the mandrel is axially formed an orifice to define an inner periphery of the mandrel. The outer periphery of the mandrel is partitioned to a mid section, first and second side sections each opposedly extending from the mid section. A plurality of slots are radially formed along said each side section of the outer periphery to allow communication between the inner and outer peripheries thereby. First and second grooves are formed in the first and second side sections of the outer periphery to intersect the slots.

The coil wounding apparatus also includes a plurality of hooks each having a base, and an upright portion extending from the base and approaching the mid section of the outer periphery. The base has an upper recess and a hole adjacent to the upper recess. The upright portions of the hooks are radially aligned with the slots to enable their reciprocal movements through the slots of the mandrel.

In an embodiment, there are further provided a first retainer member sustaining a first half number of the hooks by the holes and positioned in the orifice near the first side end of the mandrel, and a first elastic ring worn in and along the first groove and carried in said each upper recess of the first half hooks to elastically maintain said each upright portion of the corresponding hooks below the outer periphery of the mandrel. Selectively, the coil winding apparatus further comprises a second retainer member sustaining a second half number of the hooks by the holes and positioned in the orifice near the second side end of the mandrel, and a second elastic ring worn in and along the second groove and carried in said each upper recess of the second half hooks to elastically maintain said each upright portion of the corresponding hooks below the outer periphery of the mandrel.

Also provided are first and second adjusters. The first adjuster is detachably inserted through the first side end into the orifice, whereby the upright portions of the first half hooks remain above the outer periphery of the mandrel when the first adjuster is inserted from the first side end of the mandrel and below the outer periphery of the mandrel when the first adjuster is detached from the first side end of the mandrel. The second adjuster is detachably inserted through the second side end into the orifice, whereby the upright portions of the second half hooks remain above the outer periphery of the mandrel when the second adjuster is inserted from the second side end of the mandrel and below the outer periphery of the mandrel when the second adjuster is detached from the second side end of the mandrel.

The advantages of the invention are numerous in that: (1) the coil winding apparatus innovatively simplifies the steps required for forming the coil-wound article applicable to a stator for a motor such as brushless electric motors by substantially disregarding the conventionally required steps, that is, by not requiring the conventional steps for flattening or rolling the coil-wound article; (2) because the simplified coil windings are realized by simply releasing the completed coil-wound article from the mandrel by removing the adjusters without deformation of the coil-wound article, the coil-wound article of the invention substantially improves production efficiency while significantly decreasing effective rates; and (3) the coil-wound article completed and released from the cylindrical mandrel can be directly assembled to a target stator without requiring adjustment of radius measurements to the target stator, thereby improving productivity for fabricating the coil-wound article and stabilizing magnetic inductivity for the applied stator.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a mandrel according to the present invention;

FIG. 2 is a front view of the mandrel in FIG. 1;

FIG. 3 is an axially taken cross-sectional view of the mandrel in FIG. 1;

FIG. 4 is a view with each adjuster detached from the mandrel in FIG. 3;

FIG. 5 a cross-sectional view taken along line V-V in FIG, 2;

FIG. 6 is a perspective view of a hook with a ring member according to the present invention;

FIG. 7 is a schematic development view of the mandrel to show a coil winding mechanism according to the present invention; and

FIG. 8 is a perspective view showing the coil-wound article removed from the mandrel according to the present invention.

### DETAILED DESCRIPTION OF THE PREFERRED EMBODIMENTS

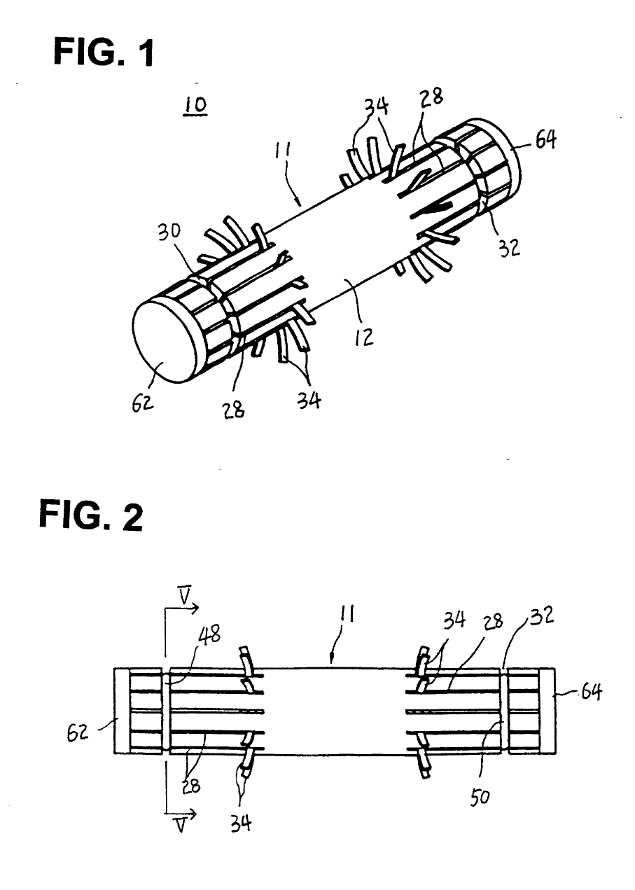

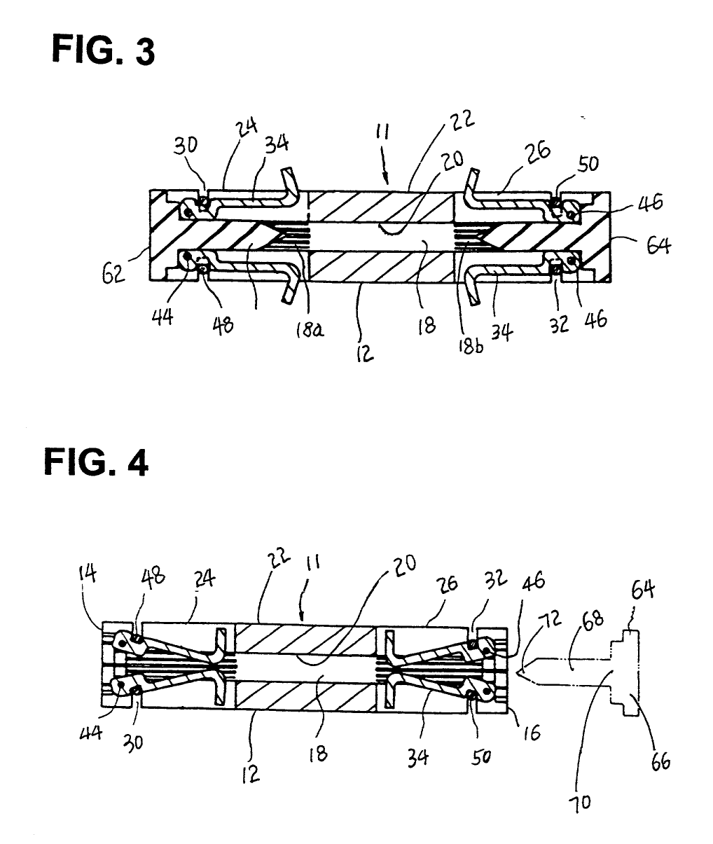

As shown in FIGS. 1 and 2, the coil winding apparatus 10 to fabricate a coil-wound article 60 shown in FIG. 8 for an electric motor, generator and alternator according to the present invention is incorporated in a mandrel 11 in cylindrical formation. As further shown in FIGS. 3 and 4, the mandrel 11 is defined by an outer periphery 12, a first side end 14 and a second side end 16. An orifice 18 is axially formed through the first and second side ends 14, 16 of the mandrel 11 so as to define an inner periphery 20 of the mandrel 11.

The outer periphery 12 of the mandrel 11 is partitioned to a mid section 22, a first side section 24 and a second side section 26 such that the side sections 24, 16 each opposedly extend from the mid section 22. That is, to the left is provided the first side section 24 and to the right is provided the second side section 26 with the side sections 24, 26 separated by the mid section 22. Each section 22, 24, 26 may be either unitary with each other or fixedly assembled to each other.

In such a construction, a plurality of slots 28 are radially formed along each side section 24, 26 of the outer periphery 12 to allow thereby communication between the outer and inner peripheries 12, 20. Also, first and second grooves 30, 32 are circularly formed in and along each predetermined circumference of the first and second side sections 24, 26 of the outer periphery 12 to intersect the slots 28. Here, it is preferred that each groove 30, 32 is formed closer to the corresponding end 14, 16 of the mandrel 11 than to the mid section 22 of the outer periphery 12. Here, it is preferred that the slots 28 are formed in an axial alignment along the first and second side sections 24, 26 of the outer periphery 12 with an even distance from the adjacent ones thereof.

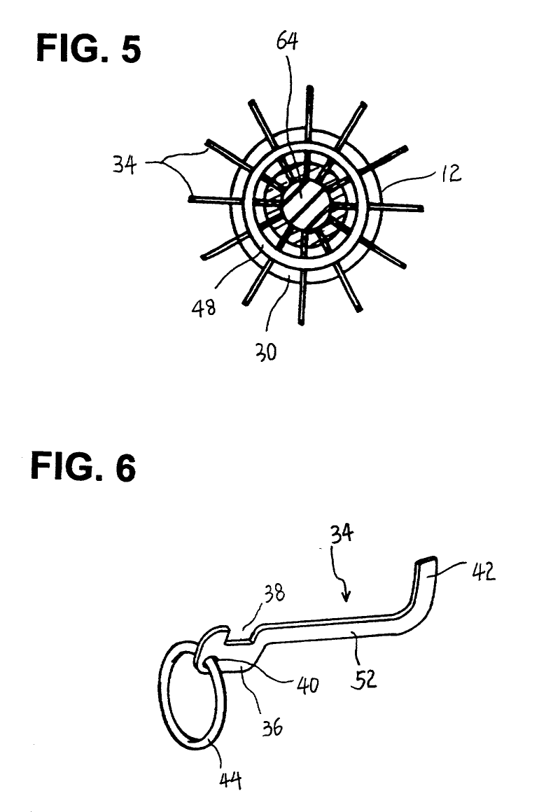

Referring to FIGS. 5 and 6, for a better performance, a plurality of hooks 34 are provided in correspondence to the slots 28. That is, each slot 28 flexibly receives therein a corresponding one of the hooks 34. Specifically, each hook 34 is partitioned to a base 36 and an upright portion 42 while the base 36 has an upper recess 38 and a hole 40 which is adjacent to the upper recess 38. The upright portion 42 is formed as an extension from the hook base 36 and approaches the mid section 22 of the outer periphery 12. In this construction, the upright portions 42 of the hooks 34 are radially aligned with the slots 28 so as to enable their reciprocal movements through the slots 28 of the mandrel 11. Here, the hooks 34 are incorporated in first half and second half in equal number to engage with the first and second retainer members 44, 46.

In order for the upright portions 42 of the hooks 34 to controllably move up and down through the slots 28, there are provided first and second retainer members 44, 46 in the orifice 18 near the first and second side ends 14, 16 of the mandrel 11 to sustain corresponding ones of the hooks 34 by the holes 40 of the hooks 34. Preferably, the retainer members 44, 46 are each formed of metallic material in shape of rings. The retainer members 44, 46 with the hooks 34 carried thereon through the hook holes 40 are each positioned in the orifice 18 toward the side ends 14, 16 of the mandrel 11 such that the retainer members 44, 46 are each placed to fit on the inner periphery 20 while facing the side ends 14, 16 of the mandrel 11, whereas the hooks 34 flexibly hanging from the retainer members 44, 46 are radially positioned in the orifice 18 such that the upright portion 42 of each hook 34 approaches the mid section 22 of the outer periphery 12. That is, each upright portion 42 of the hooks 34 is centrifugally aligned to facilitate fluctuation through the slots 28.

Also provided are first and second elastic rings 48, 50 respectively worn in and along the first and second grooves 30, 32 so as to be carried in each upper recess 38 of the hooks 34. As illustrated in FIG. 4, the elastic rings 48, 50 each serve to elastically maintain corresponding upright portions 42 of the hooks 34 below the outer periphery 12 of the mandrel.

In a preferred version, each hook 34 includes a straight portion 52 between the upright portion 42 and the base 36. So an angle formed by the upright portion 42 and the straight portion 52 becomes substantially less than 90 degrees. For a better performance, the angle formed by the upright portion 42 and the straight portion 52 may range about between 90 degrees and 50 degrees.

To facilitate coil winding around the upright portions 42 of the hooks 34 and remove a completed coil-wound article 60 in FIG. 8 from the mandrel 11, the coil winding apparatus 10 further comprises first and second adjusters 62, 64 to control the hook fluctuation through the slots 28. The first and second adjusters 62, 64 each are inserted through the first and second side ends 14, 16 of the mandrel 11 into the orifice 18 so that the upright portions 42 of the hooks 34 can remain above the outer periphery 12 of the mandrel when inserted from the side ends 14, 16 of the mandrel 11 but remain below the outer periphery 12 of the mandrel 11 when detached from the side ends 14, 16 of the mandrel.

The first and second adjusters 62, 64 each has a base cap 66 and an insertion bar 68. The base cap 66 has an inner central portion 70. The base cap 66 is substantially equivalent to the mandrel 11 in diameter. The insertion bar 68 extends from the inner central portion 70 of the base cap 66. The insertion bar 68 is substantially equivalent to or less than the orifice 18 in diameter. Preferably, the base cap 66 may be stepped toward the insertion bar 68 which is substantially tapered toward a tip 72 thereof.

In an embodiment, the orifice 18 may be blocked in the middle thereof below the mid section 22 of the outer periphery 12 to divide the orifice 18 into first and second cavities 18a, 18b. So the first and second retainer members 44, 46 are respectively maintained in the first and second cavities 18a, 18b.

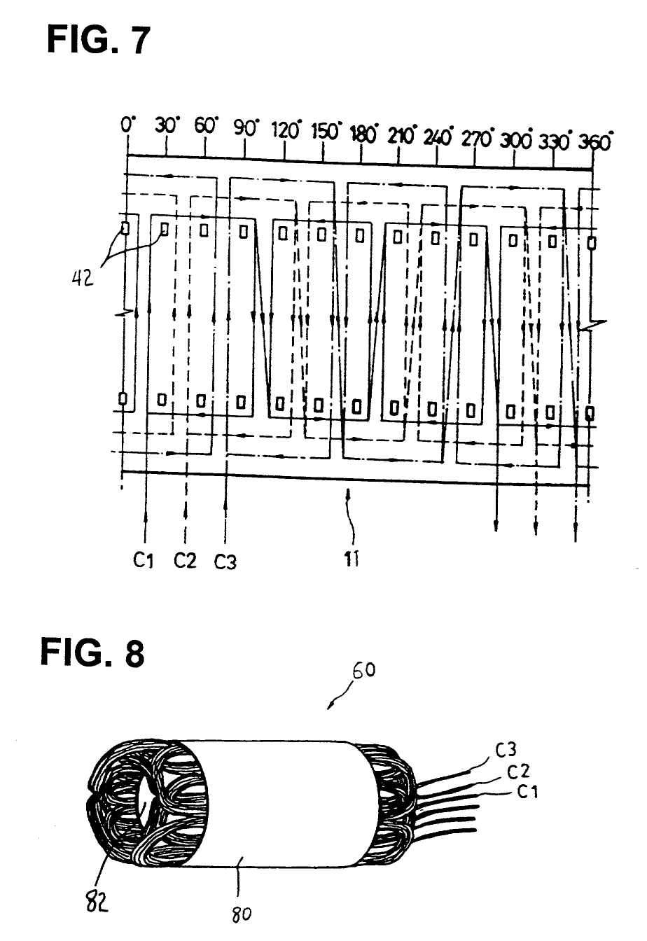

In such a construction, each upright portion 42 of the hooks 34 is utilized to implement a coil winding operation in a process as shown in FIG. 7, wherein coils C1, C2, C3 are regularly wound around upright portions 42 that remain above the outer periphery 12 of the mandrel 11. As shown in FIG. 8, the coil-wound article 60 may be utilized for an electric motor, an electric generator, or an electric alternator using insulators 80, 82.

An advantage of the invention is the coil winding apparatus 10 innovatively simplifies the steps required for forming the coil-wound article 60 applicable to a stator for a motor such as brushless electric motors by substantially disregarding the conventionally required steps, that is, by not requiring the conventional steps for flattening or rolling the coil-wound article.

Further, because the simplified coil windings are realized by simply releasing the completed coil-wound article from the mandrel by removing the adjusters without deformation of the coil-wound article, the coil-wound article of the invention substantially improves production efficiency while significantly decreasing effective rates. In addition, the coil-wound article completed and released from the cylindrical mandrel can be directly assembled to a target stator without requiring adjustment of radius measurements to the target stator, thereby improving productivity for fabricating the coil-wound article and stabilizing magnetic inductivity for the applied stator.

Although the invention has been described in considerable detail with reference to certain preferred versions thereof, other versions are possible by converting the aforementioned construction. Therefore, the scope of the invention shall not be limited by the specification specified above and the appended claims.

What is claimed is:

1. A coil winding apparatus to fabricate a coil-wound article, comprising:
a) a mandrel having an outer periphery, first and second side ends, wherein through the first and second side ends of the mandrel is axially formed an orifice to define an inner periphery of the mandrel, wherein the outer periphery of the mandrel is partitioned to a mid section, first and second side sections each opposedly extending from the mid section, wherein a plurality of slots are radially formed along said each side section of the outer periphery to allow communication between the inner and outer peripheries thereby, wherein first and second grooves are formed in the first and second side sections of the outer periphery to intersect the slots;
b) a plurality of hooks each having a base, and an upright portion extending from the base and approaching the mid section of the outer periphery, wherein the base has an upper recess and a hole adjacent to the upper recess, wherein the upright portions of the hooks are radially aligned with the slots to enable their reciprocal movements through the slots of the mandrel;
c) a first retainer member sustaining a first half number of the hooks by the holes and positioned in the orifice near the first side end of the mandrel; and
d) a first elastic ring worn in and along the first groove and carried in said each upper recess of the first half hooks to elastically maintain said each upright portion of the corresponding hooks below the outer periphery of the mandrel.

2. The coil winding apparatus of claim 1 further comprising:
a) a second retainer member sustaining a second half number of the hooks by the holes and positioned in the orifice near the second side end of the mandrel; and
b) a second elastic ring worn in and along the second groove and carried in said each upper recess of the second half hooks to elastically maintain said each upright portion of the corresponding hooks below the outer periphery of the mandrel.

3. The coil winding apparatus of claim 1 wherein said each hook includes a straight portion between the upright portion and the base, wherein an angle formed by the upright portion and the straight portion of said each hook is substantially less than 90 degrees.

4. The coil winding apparatus of claim 3 wherein the angle formed by the upright portion and the straight portion of said each hook is about between 90 degrees and 50 degrees.

5. The coil winding apparatus of claim 1 wherein the retainer members are metallic rings.

6. The coil winding apparatus of claim 1 wherein the orifice is blocked in the middle thereof below the mid section of the outer periphery of the mandrel to divide the orifice into first and second cavities, whereby the first and second retainer members are respectively maintained in the first and second cavities.

7. The coil winding apparatus of claim 6 wherein the retainer members are metallic rings.

8. The coil winding apparatus of claim 1 wherein the slots are axially aligned along the first and second side sections of the outer periphery.

9. The coil winding apparatus of claim 8 wherein the slots each are evenly distanced from the adjacent ones thereof.

10. A coil winding apparatus to fabricate a coil-wound article, comprising:
a) a mandrel having an outer periphery, first and second side ends, wherein through the first and second side ends of the mandrel is axially formed an orifice to define an inner periphery of the mandrel, wherein the outer periphery of the mandrel is partitioned to a mid section, first and second side sections each opposedly extending from the mid section, wherein a plurality of slots are radially formed along said each side section of the outer periphery to allow communication between the inner and outer peripheries thereby, wherein first and second grooves are formed in the first and second side sections of the outer periphery to intersect the slots;
b) a plurality of hooks each having a base, and an upright portion extending from the base and approaching the mid section of the outer periphery, wherein the base has an upper recess and a hole adjacent to the upper recess, wherein the upright portions of the hooks are radially aligned with the slots to enable reciprocal movements through the slots of the mandrel;
c) a first retainer member sustaining a first half number of the hooks by the holes and positioned in the orifice near the first side end of the mandrel;
d) a first elastic ring worn in and along the first groove and carried in said each upper recess of the first half hooks to elastically maintain said each upright portion of the corresponding hooks below the outer periphery of the mandrel; and
e) a first adjuster detachably inserted through the first side end into the orifice, whereby the upright portions of the first half hooks remain above the outer periphery of the mandrel when the first adjuster is inserted from the first side end of the mandrel and below the outer periphery of the mandrel when the first adjuster is detached from the first side end of the mandrel.

11. The coil winding apparatus of claim 10 wherein the first adjuster comprises:
a) a base cap having an inner central portion, wherein the base cap is substantially equivalent to the mandrel in diameter; and
b) an insertion bar extending from the inner central portion of the base cap, wherein the insertion bar is substantially equivalent to or less than the orifice in diameter.

12. The coil winding apparatus of claim 10 further comprising:
a) a second retainer member sustaining a second half number of the hooks by the holes and positioned in the orifice near the second side end of the mandrel;
b) a second elastic ring worn in and along the second groove and carried in said each upper recess of the second half hooks to elastically maintain said each upright portion of the corresponding hooks below the outer periphery of the mandrel; and
c) a second adjuster detachably inserted through the second side end into the orifice, whereby the upright portions of the second half hooks remain above the outer periphery of the mandrel when the second adjuster is inserted from the second side end of the mandrel and below the outer periphery of the mandrel when the second adjuster is detached from the second side end of the mandrel.

13. The coil winding apparatus of claim 12 wherein the adjusters each comprise:
a) a base cap having an inner central portion, wherein the base cap is substantially equivalent to the mandrel in diameter; and
b) an insertion bar extending from the inner central portion of the base cap, wherein the insertion bar is substantially equivalent to or less than the orifice in diameter.

14. The coil winding apparatus of claim 13 wherein the base cap is stepped toward the insertion bar.

15. The coil winding apparatus of claim 13 wherein the insertion bar is substantially tapered toward a tip thereof.

16. The coil winding apparatus of claim 10 wherein said each hook includes a straight portion between the upright portion and the base, wherein an angle formed by the upright portion and the straight portion of said each hook is substantially less than 90 degrees.

17. The coil winding apparatus of claim 16 wherein the angle formed by the upright portion and the straight portion of said each hook is about between 90 degrees and 50 degrees.

18. The coil winding apparatus of claim 12 wherein the retainer members are metallic rings.

19. The coil winding apparatus of claim 10 wherein the orifice is blocked in the middle thereof below the mid section of the outer periphery of the mandrel to divide the orifice into first and second cavities, wherein the first and second retainer members are respectively maintained in the first and second cavities.

20. The coil winding apparatus of claim 10 wherein the slots are axially aligned along the first and second side sections of the outer periphery.

21. The coil winding apparatus of claim 20 wherein the slots each are evenly distanced from the adjacent ones thereof.
